(19) United States
(12) Patent Application Publication
(10) Pub. No.: US 2008/0044321 A1
(43) Pub. Date: Feb. 21, 2008

(54) POWER SUPPLY UNIT FOR GENERATING PLASMA AND PLASMA APPARATUS INCLUDING THE SAME

(75) Inventor: Jeong-Beom LEE, Gwangju-si (KR)

Correspondence Address: MARGER JOHNSON & MCCOLLOM, P.C., 210 SW MORRISON STREET, SUITE 400, PORTLAND, OR, 97204, US

(73) Assignee: JUSUNG ENGINEERING CO., LTD., Kwangju-shi (KR)

(21) Appl. No.: 11/923,425

(22) Filed: Oct. 24, 2007

Related U.S. Application Data
(62) Division of application No. 11/054,777, filed on Feb. 9, 2005.

(30) Foreign Application Priority Data
Feb. 9, 2004 (KR) 2004-0008224
Feb. 2, 2005 (KR) 2005-0009453

(51) Int. Cl. B01J 19/12

(52) U.S. Cl. 422/186.29

(57) ABSTRACT

A power supply unit includes: a power source generating a radio frequency power; an impedance matching box connected to the power source and matching an internal impedance of the power source and a load impedance; a first feed line connected to the impedance matching box; a radio frequency distributing means connected to the first feed line; and a plasma electrode connected to the radio frequency distributing means, the radio frequency distributing means supplying the radio frequency power to a plurality of points of the plasma electrode.

### BACKGROUND OF THE INVENTION

The present invention is a divisional application of U.S. patent application Ser. No. 11/054,777, filed Feb. 9, 2005, and claims the benefit of Korean Patent Applications No. 2004-0008224 filed in Korea on Feb. 9, 2004 and No. 2005-0009453 filed in Korea on Feb. 2, 2005, each of which is hereby incorporated by reference.

### FIELD OF THE INVENTION

The present invention relates to a power supply unit for generating plasma, and more particularly, to a power supply unit which supplies a radio frequency (RF) power to a plurality of points of a plasma electrode and a plasma apparatus including the power supply unit.

### DESCRIPTION OF THE RELATED ART

Flat panel display (FPD) devices having portability and low power consumption have been a subject of increasing research in the present information age. Among the various types of FPD devices, liquid crystal display (LCD) devices are commonly used in notebook and desktop computers because of their high resolution, capability of displaying colored images, and high quality image display.

In general, an LCD device is a non-emissive device having an array substrate, a color filter substrate and a liquid crystal layer interposed between the array substrate and the color filter substrates, and displaying images by making use of optical anisotropy properties of the liquid crystal layer. In addition, an LCD device is fabricated by repeating a deposition step of a thin film on a substrate, a photolithographic step using a photoresist, a selective etching step of the thin film and a cleaning step of the substrate. These steps for a fabrication process of an LCD device may be performed using an apparatus having a process chamber under an optimum condition. A plasma apparatus where source gases are excited to radicals of a plasma state by a high frequency power is used for deposition, etching and cleaning steps of an LCD device. Recently, a plasma enhanced chemical vapor deposition (PECVD) apparatus has been widely used as a plasma apparatus.

A plasma apparatus includes a radio frequency (RF) power source, an impedance matching box (IMB) and a power supply unit having a plasma electrode supplying an RF power to source gases to generate plasma. A plasma apparatus may include a PECVD apparatus for fabricating a thin film, an etcher for etching a thin film, and a dry cleaning apparatus for cleaning a substrate. Since processes are similar to each other in a PECVD apparatus, an etcher and a dry cleaning apparatus, a PECVD apparatus will be illustrated as a plasma apparatus.

FIG. 1 is a schematic cross-sectional view showing a PECVD apparatus according to the related art. In FIG. 1, a PECVD apparatus includes a process chamber 10 having a susceptor 20 and a plasma electrode 40 therein and an RF power source 50 connected to the process chamber 10. After a substrate 30 is placed on the susceptor 20 by a robot arm (not shown), source gases are injected into the process chamber 10 through a gas inlet pipe (not shown). Next, the RF power source 50 supplies an RF power to the plasma electrode 40 through an impedance matching box 60 and a first feed line 70, and the source gases are excited to be a plasma state by the RF power. The excited source gases of a plasma state react on the substrate 30 and then are evacuated through an outlet pipe 80 after finishing a fabrication process.

The plasma electrode 40 may be formed as one body with a shower head (not shown) for spraying the source gases or with the susceptor 20. In addition, the plasma electrode 40 may be formed both in the shower head and in the susceptor 20. FIG. 1 shows the plasma electrode 40 and the shower head formed as one body. The susceptor 20, a chamber body 11 connected to the susceptor 20, and a chamber lid 12 are grounded.

The RF power is supplied to a central portion of the plasma electrode 40 on the basis of a process uniformity and the supplied RF power is transmitted through a surface of the plasma electrode 40 due to skin effect. Accordingly, an RF electric field is generated between the plasma electrode 40 and the susceptor 20, and the source gases are excited to be a plasma by the RF electric field. Since the plasma between the plasma electrode 40 and the susceptor 20 has a uniformity corresponding to a uniformity of the RF electric field, a uniform RF electric field is a subject factor for a fabrication process.

Since a standing wave of an RF power due to wave effect exists on a surface of the plasma electrode 40, a voltage slightly varies with a position of the plasma electrode 40. In addition, an RF power leakage at a boundary of the plasma electrode 40 causes a non-uniformity of voltage distribution. When a substrate has a size relatively smaller than a wavelength of the standing wave of an RF power, an effect of the standing wave on a fabrication process is negligible. However, as a size of a substrate increases, for example, a seventh generation substrate of 1870 mm by 2200 mm, the substrate size approaches the wavelength of the standing wave of an RF power. Accordingly, the standing wave of an RF power has been the subject factor of a fabrication process for a uniform RF electric field.

FIG. 2 is a schematic view showing an RF electric field in a PECVD apparatus according to the related art. In FIG. 2, a substrate of 1870 mm by 2200 mm is placed on a susceptor 20 and an RF power of 13.56 MHz is applied to a plasma electrode 40 (of FIG. 1). FIG. 2 shows a cross-section of an RF electric field, resulting from a simulation, at a position separated from the susceptor 20 by 5 mm. An average region “C” represents the RF electric field having an intensity corresponding to an average value and a first low region “D” represents the RF electric field having an intensity smaller than that of the average region “C” by 0.2% of the average value. In addition, a first high region “B” represents the RF electric field having an intensity greater than that of the average region “C” by 0.2% of the average value, and a second high region “A” represents the RF electric field having an intensity greater than that of the first high region “B” by 0.2% of the average value.

Accordingly, the RF electric field has a maximum intensity at a central portion of the plasma electrode 40 and the intensity of the RF electric field decreases as going to a boundary portion of the plasma electrode 40 because of the standing wave of the RF power. Since the intensity of the RF electric field continuously varies, the distribution of the RF electric field does not have a step substantially and a border line for a step of FIG. 2 is adopted just for illustration' sake.

To solve the above problems of non-uniformity in the RF electric field, a design of a impedance matching box is changed or a frequency of the RF power is reduced for lengthen the wavelength of the RF power. However, an electric structure becomes complicated or a property of a thin film is deteriorated.

### SUMMARY OF THE INVENTION

Accordingly, the present invention is directed to a power supply unit for generating plasma and a plasma apparatus using the power supply unit that substantially obviates one or more of the problems due to limitations and disadvantages of the related art.

An object of the present invention is to provide a power supply unit that supplies an RF power symmetrically to improve a uniformity of an RF electric field between a plasma electrode and a susceptor.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a power supply unit includes: a power source generating a radio frequency power; an impedance matching box connected to the power source and matching an internal impedance of the power source and a load impedance; a first feed line connected to the impedance matching box; a radio frequency distributing means connected to the first feed line; and a plasma electrode connected to the radio frequency distributing means, the radio frequency distributing means supplying the radio frequency power to a plurality of points of the plasma electrode.

In another aspect, a plasma apparatus includes: a process chamber treating a substrate; a power source outside the process chamber and generating a radio frequency power; an impedance matching box connected to the power source and matching an internal impedance of the power source and a load impedance; a first feed line connected to the impedance matching box; a distributing part over the process chamber, the first feed line being connected to a central portion of the distributing part; a plasma electrode in the process chamber; a plurality of second feed lines connecting the distributing part and the plasma electrode, the distributing part and the plasma electrode supplying the radio frequency power to a plurality of points of the plasma electrode; and a susceptor facing the plasma electrode and having the substrate thereon.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic cross-sectional view showing a PECVD apparatus according to the related art;

FIG. 2 is a schematic view showing an RF electric field in a PECVD apparatus according to the related art;

FIG. 3 is a schematic cross-sectional view of a plasma apparatus according to an exemplary embodiment of the present invention;

FIG. 4 is a schematic plane view showing an RF power distributing means of a plasma apparatus according to an exemplary embodiment of the present invention;

FIG. 5 is a schematic view showing an RF electric field generated between a plasma electrode and a susceptor of FIG. 4;

FIG. 6 is a schematic plane view showing an RF power distributing means of a plasma apparatus according to another exemplary embodiment of the present invention;

FIG. 7 is a schematic view showing an RF electric field generated between a plasma electrode and a susceptor of FIG. 6;

FIGS. 8 and 9 are schematic perspective views showing an RF power distributing means of a plasma apparatus according to another embodiment of the present invention;

FIG. 10 is a schematic perspective view showing an RF power distributing means of a plasma apparatus according to another exemplary embodiment of the present invention; and

FIG. 11 is a schematic perspective view showing an RF power distributing means of a plasma apparatus according to another exemplary embodiment of the present invention.

### DETAILED DESCRIPTION OF THE PREFERRED EMBODIMENTS

Reference will now be made in detail to the preferred embodiments, examples of which are illustrated in the accompanying drawings.

Since the present invention relates to a plasma apparatus such as a plasma enhanced chemical vapor deposition (PECVD) apparatus and an etcher where process gases are excited to a plasma state in a chamber and contact a substrate, the plasma apparatus may be a fabrication apparatus for a liquid crystal display (LCD) device or a semiconductor device. In addition, the substrate may be a glass substrate for an LCD device or a wafer for a semiconductor device.

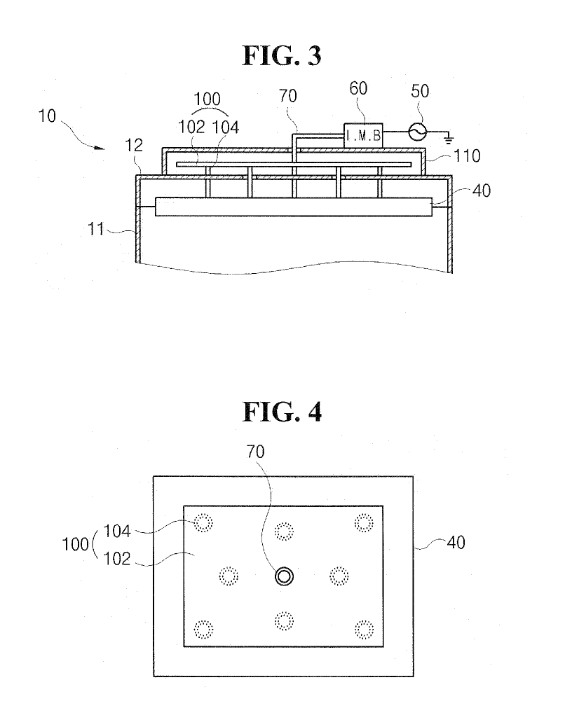

FIG. 3 is a schematic cross-sectional view of a plasma apparatus according to an exemplary embodiment of the present invention.

In FIG. 3, a plasma apparatus includes a process chamber 10 having a susceptor (not shown) and a plasma electrode 40 therein and a radio frequency (RF) power source 50 connected to the plasma electrode 40 through an impedance matching box 60, a first feed line 70 and an RF power distributing means 100. The process chamber 10 may consist of a chamber lid 12 and a chamber body 11. The RF power distributing means 100 includes a distributing part 102 of a plate shape over the chamber lid 12 and a plurality of second feed lines 104 connecting the distributing part 102 and the plasma electrode 40. Each second feed line 104 may have a cylindrical shape.

An RF power is supplied to the distributing part 102 through the first feed line 70. Accordingly, one end of the first feed line 70 is connected to the impedance matching box 60 and the other end of the first feed line 70 is connected to a central portion of the distributing part 102. The plurality of second feed lines 104 are connected to the plasma electrode 40 through a plurality of through holes (not shown) of the chamber lid 12. Accordingly, the RF power is applied to a plurality of points of the plasma electrode 40 through the plurality of second feed lines 104. The chamber lid 12 functions as a electrostatic shield preventing an electric field interference between the plasma electrode 40 and the distributing part 102. The distributing part 102, the first feed line 70 and the plurality of second feed lines 104 may include a conductive metallic material.

The distributing part 102 may be surrounded by an additional housing to prevent interference from exterior. Accordingly, a housing 110 may be disposed over the chamber lid 12 such that the distributing part 102 is disposed in the housing 110 and the impedance matching box 60 is disposed over the housing 110. When the chamber lid 12 is grounded, the housing is also grounded. In addition, the housing 110 has a through hole (not shown) for the first feed line 70.

FIG. 4 is a schematic plane view showing an RF power distributing means of a plasma apparatus according to an exemplary embodiment of the present invention.

In FIG. 4, the distributing part 102 is connected to the plasma electrode 40 through eight second feed lines 104. Even though the distributing part 102 has a rectangular plate shape in FIG. 4, the distributing part 102 may have various shapes in another embodiment.

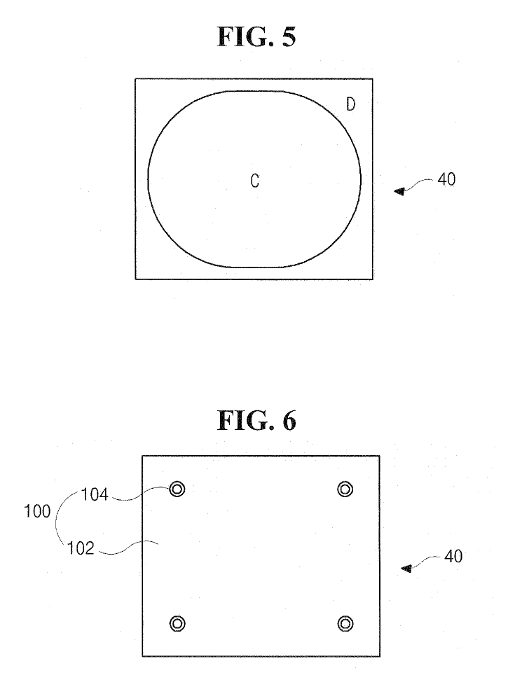

FIG. 5 is a schematic view showing an RF electric field generated between a plasma electrode and a susceptor of FIG. 4.

In FIG. 5, a substrate of 1870 mm by 2200 mm is placed on a susceptor (not shown) and an RF power of 13.56 MHz is applied to a plasma electrode 40. FIG. 2 shows a cross-section of an RF electric field, resulting from a simulation, at a position separated from the susceptor by 5 mm. An average region “C” represents the RF electric field having an intensity corresponding to an average value and a first low region “D” represents the RF electric field having an intensity smaller than that of the average region “C” by 0.2% of the average value. The average region “C” corresponding to a central portion of the plasma electrode 40 covers over a half of the plasma electrode 40 and the first low region “D” appears at an edge portion of the plasma electrode 40. In addition, first and second high regions “B” and “A,” which represent the RF electric field having an intensity greater than that of the average region “C” by 0.2% of the average value and the RF electric field having an intensity greater than that of the first high region “B” by 0.2% of the average value, respectively, do not appear. Accordingly, a uniformity of the RF electric field is improved.

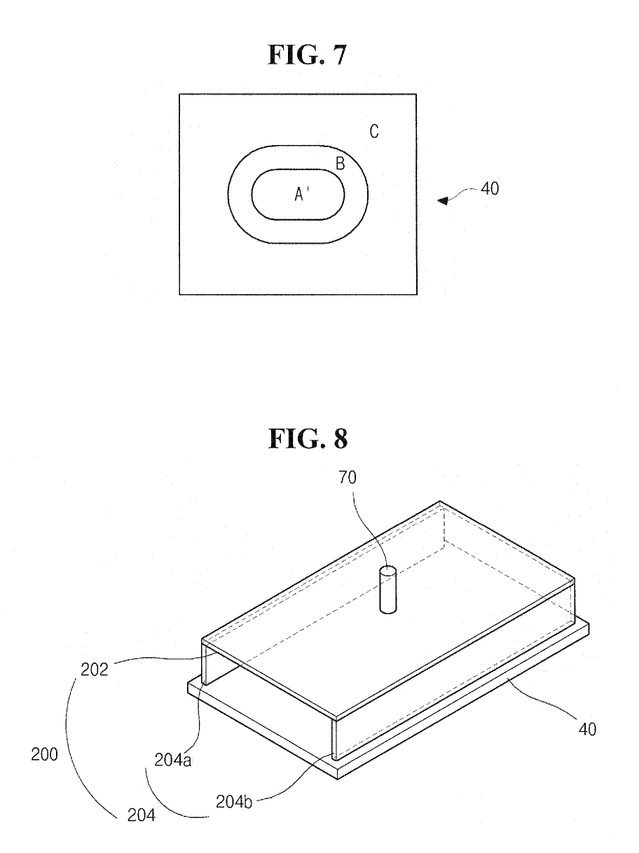

FIG. 6 is a schematic plane view showing an RF power distributing means of a plasma apparatus according to another exemplary embodiment of the present invention and FIG. 7 is a schematic view showing an RF electric field generated between a plasma electrode and a susceptor of FIG. 6.

In FIGS. 6 and 7, the distributing part 102 is connected to the plasma electrode 40 through four second feed lines 104. A region “A′” represents the RF electric field having an intensity between the intensity of the first high region “A” and the intensity of the second high region “A.” An average region “C,” which represents the RF electric field having an intensity corresponding to an average value, appears at an edge portion of the plasma electrode 40. The region “A′” covers a central portion of the plasma electrode 40 and the first high region “B,” which represent the RF electric field having an intensity greater than that of the average region “C” by 0.2% of the average value, appears between the average region “C” and the region “A′.” Since the average region “C” covers nearly a half of the plasma electrode 40 and a first low region “D” does not appear, a uniformity of the RF electric field is improved.

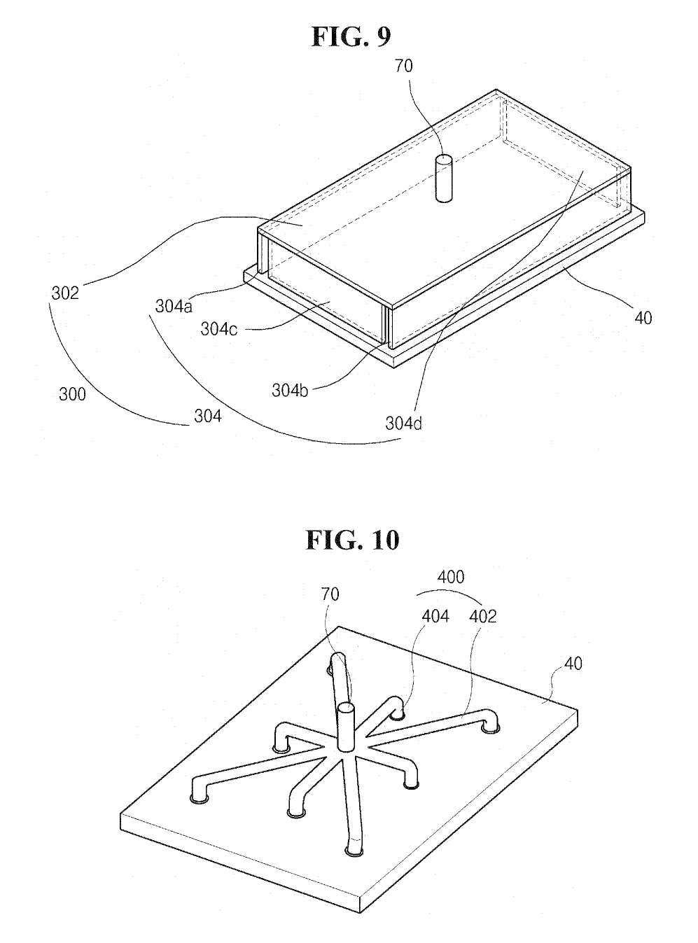

FIGS. 8 and 9 are schematic perspective views showing an RF power distributing means of a plasma apparatus according to another embodiment of the present invention.

In FIGS. 8 and 9, an RF power distributing means 200 and 300 includes a distributing part 202 and 302 of a plate shape and a plurality of second feed lines 204 and 304 of a plate shape. A first feed line 70 is connected to a central portion of the distributing part 202 and 302 and an RF power is applied to the distributing part 202 and 302 through the first feed line 70. The plurality of second feed lines 202 and 302 are connected to a plasma electrode 40.

In FIG. 8, the plurality of second feed lines 204 include first and second plates 204a and 204b having a rectangular plate shape and facing each other. The first and second plates 204a and 204b connect two edge sides of the distributing part 202 and the plasma electrode 40.

In FIG. 9, the plurality of second feed lines 304 include first, second, third and fourth plates 204a, 204b, 204c and 204d having a rectangular plate shape. The first and second plates 204a and 204b face each other, and the third and fourth plates 204c and 204d face each other. The first, second, third and fourth plates 204a, 204b, 204c and 204d connect four edge sides of the distributing part 202 and the plasma electrode 40.

Even though not shown in FIGS. 8 and 9, each second feed line 204 and 304 may be formed of a plurality of sub-plates spaced apart from each other. Accordingly, each of the first and second plates 204a and 204b of FIG. 8 and the first, second, third and fourth plates 204a, 204b, 204c and 204d may include a plurality of sub-plates disposed side by side at edges sides between the distributing part and the plasma electrode in another embodiment.

FIG. 10 is a schematic perspective view showing an RF power distributing means of a plasma apparatus according to another exemplary embodiment of the present invention.

In FIG. 10, an RF power distributing means 400 includes a distributing part 402 and a plurality of second feed lines 404. The distributing part 402 has a plurality of radial branches of a cylindrical shape and a first feed line 70 is connected to a central portion of the distributing part 402. Each second feed line 404 extending from an end of each radial branches is connected to a plasma electrode 40. Since the distributing part 402 does not completely cover the plasma electrode 40, a parasitic capacitance or a stray capacitance between the distributing part 402 and the chamber lid or between the distributing part 402 and the housing may be reduced. Accordingly, a leakage of the RF power is minimized.

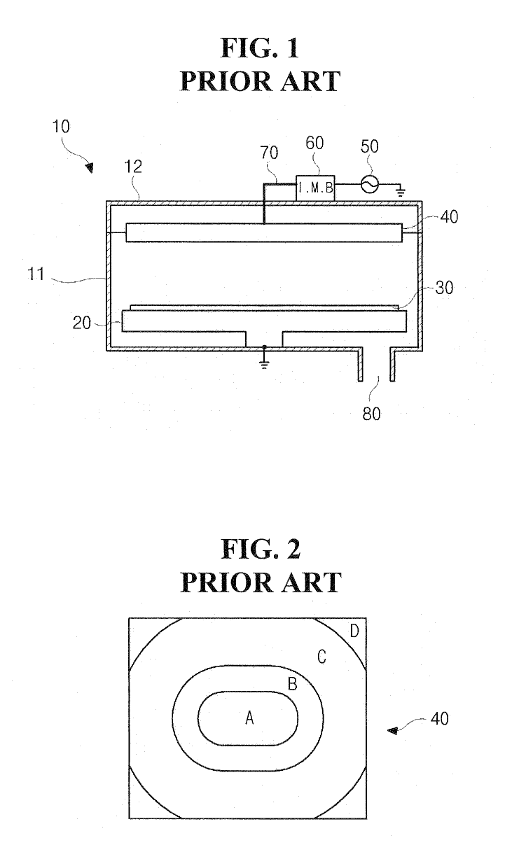

Even though the plurality of radial branches of the distributing part 402 have a different length from each other in FIG. 10, the distributing part 402 may be formed such that the plurality of radial branches have a substantially equal length. In addition, even though the plurality of second feed lines 404 have asymmetrical positions with respect to the first feed line 70 in FIG. 1 0, the plurality of second feed lines 404 may have symmetrical positions with respect to the first feed line 70 in another embodiment. The connection position of the plurality of second feed lines 404 may be determined on the basis of a fabrication process through a simulation. In addition, even though the plurality of radial branches are parallel to the plasma electrode 40 in FIG. 10, the plurality of radial branches may be inclined with respect to the plasma electrode 40 in another embodiment. A chamber lid (not shown) may be disposed between the RF power distributing means 400 and the plasma electrode 40, and the plurality of second feed lines 404 may be connected to the plasma electrode 40 through a plurality of through holes (not shown) in the chamber lid.

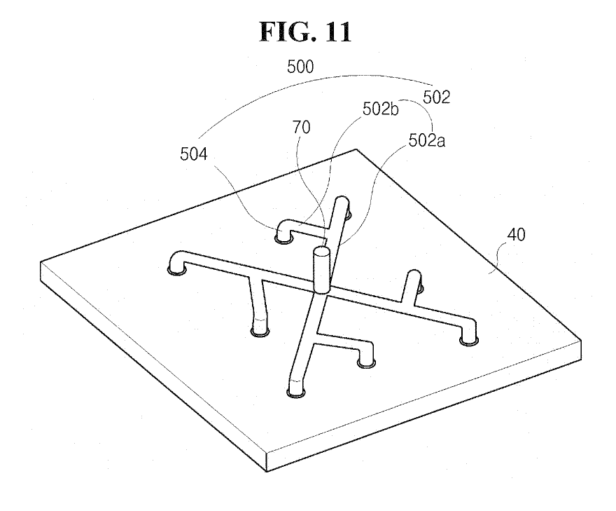

FIG. 11 is a schematic perspective view showing an RF power distributing means of a plasma apparatus according to another exemplary embodiment of the present invention.

In FIG. 11, an RF power distributing means 500 includes a first distributing part 502a, a second distributing part 502b and a plurality of second feed lines 504. The first distributing part 502a has a plurality of radial branches of a cylindrical shape and a first feed line 70 is connected to a central portion of the first distributing part 502a. The second distributing part 502b has a plurality of branches extending from each radial branch of the first distributing part 502a. Each second feed line 504 extending from an end of the first and second distributing parts 502a and 502b is connected to a plasma electrode 40. For example, the first distributing part 502a has symmetric four radial branches and the second distributing part 502b has four branches each extending from each radial branch. As a result, the RF power may be applied to the plasma electrode 40 through eight electric paths from the first feed line 70 to the end of the first and second distributing parts 502a and 502b. Since a distance from the first feed line 70 to the end of each first distributing part 502a is substantially the same as a distance from the first feed line 70 to the end of each second distributing part 502b, the RF power may be applied to the plasma electrode 40 through the eight electric paths having an equal length. Accordingly, the RF power may be applied to the plasma electrode 40 at the same time.

In a plasma apparatus having an RF power distributing means according to an embodiment of the present invention, a uniformity of an RF electric field between a plasma electrode and a susceptor is improved and a uniformity of fabrication processes such as deposition and etching is also improved.

It will be apparent to those skilled in the art that various modifications and variations can be made in the apparatus having an RF power distributing means without departing from the spirit or scope of the invention. Thus, it is intended that the present invention covers the modifications and variations of this invention provided they come within the scope of the appended claims and their equivalents.

What is claimed is:

1. A power supply unit comprising:
a power source generating a radio frequency power;
an impedance matching box connected to the power source and matching an internal impedance of the power source and a load impedance;
a first feed line connected to the impedance matching box;
a radio frequency distributing means connected to the first feed line, wherein the radio frequency distributing means comprises:
a distributing part having a plate shape, the first feed line being connected to a central portion of the distributing part; and
a plurality of second feed lines connecting the distributing part and the plasma electrode; and
a plasma electrode connected to the radio frequency distributing means, the radio frequency distributing means supplying the radio frequency power to a plurality of points of the plasma electrode.

2. The power supply unit according to claim 1, wherein the plurality of second feed lines have a cylindrical shape.

3. The power supply unit according to claim 1, wherein the plurality of second feed lines have a plate shape.

4. The power supply unit according to claim 3, wherein the plurality of second feed lines include first and second plates facing each other and connecting two edge sides of the distributing part and the plasma electrode.

5. The power supply unit according to claim 3, wherein the plurality of second feed lines include first, second, third and fourth plates connecting four edge sides of the distributing part and the plasma electrode, the first and second plates facing each other and the third and fourth plates facing each other.

6. The power supply unit according to claim 1, wherein the radio frequency power is symmetrically supplied to the plurality of points of the plasma electrode.

7. The power supply unit according to claim 1, wherein the distributing part is parallel to the plasma electrode.

8. A plasma apparatus comprising:
a process chamber treating a substrate;
a power source outside the process chamber and generating a radio frequency power;
an impedance matching box connected to the power source and matching an internal impedance of the power source and a load impedance;
a first feed line connected to the impedance matching box;
a distributing part over the process chamber, the first feed line being connected to a central portion of the distributing part, wherein the distributing part has a plate shape and the first feed line is connected to a central portion of the distributing part;
a plasma electrode in the process chamber;
a plurality of second feed lines connecting the distributing part and the plasma electrode, the distributing part and the plasma electrode supplying the radio frequency power to a plurality of points of the plasma electrode; and
a susceptor facing the plasma electrode and having the substrate thereon.

9. The plasma apparatus according to claim 8, further comprising a housing surrounding the distributing part, wherein the distributing part has a plate shape and the first feed line is connected to a central portion of the distributing part.

10. The plasma apparatus according to claim 8, wherein the plurality of second feed lines connect the distributing part and the plasma electrode through the process chamber.
